(19) United States
(12) Patent Application Publication
(10) Pub. No.: US 2025/0333598 A1
(43) Pub. Date: Oct. 30, 2025

(54) PREPARATION METHOD OF LIQUID CRYSTAL SYNERGISTIC HIGH-CONDUCTIVITY SILICONE RUBBER COMPOSITE MATERIAL

(71) Applicants: Guangdong University of Petrochemical Technology, Maoming City (CN); Maoming Huanxing New Materials Co., Ltd., Maoming City (CN); Maoming Green Chemical Research Institute, Maoming City (CN)

(72) Inventors: Tiwen XU, Maoming City (CN); Shitao LI, Maoming City (CN); Fei YAN, Maoming City (CN); Kaiyang HUANG, Maoming City (CN); Jianfeng BAN, Maoming City (CN)

(21) Appl. No.: 19/260,783

(22) Filed: Jul. 7, 2025

Related U.S. Application Data
(63) Continuation of application No. PCT/CN2023/137362, filed on Dec. 8, 2023.

(30) Foreign Application Priority Data
Sep. 15, 2023 (CN) 202311194561.5

(51) Int. Cl. C08L 75/04; B29C 43/00; B29K 83/00; B29K 105/00; C08G 18/24; C08G 18/32; C08G 18/76; C08J 3/20; C08K 3/04; C08K 5/01; C08L 83/04

(52) U.S. Cl. CPC C08L 75/04; B29C 43/003; C08G 18/246; C08G 18/3215; C08G 18/7614; C08J 3/203; C08K 3/04; C08K 5/01; C08L 83/04; B29K 2083/00; B29K 2105/0023; B29K 2995/0005; C08G 2250/00; C08J 2375/04; C08J 2383/07; C08K 2201/001; C08L 2205/12

(57) ABSTRACT

A preparation method of liquid crystal synergistic high-conductivity silicone rubber composite is provided, including following steps: firstly, synthesizing BP6; then synthesizing FLCPU; finally, mixing VMQ and FLCPU by mechanical blending, then adding conductive carbon black and 2,5-Dimethyl-2,5-bis(hexyl) vulcanizing agent in sequence, then obtaining FLCPU modified VMQ/CCB rubber compound; and hot-pressing the rubber compound on a flat vulcanizer to obtain a finished product, and detecting the material of the finished product before and after modification to extract data.

### CROSS-REFERENCE TO RELATED APPLICATIONS

This application is a continuation of International Patent Application No. PCT/CN2023/137362, filed on Dec. 8, 2023, and claims priority of Chinese Patent Application No. 202311194561.5, filed on Sep. 15, 2023. The contents of International Patent Application No. PCT/CN2023/137362 and Chinese Patent Application No. 202311194561.5 are hereby incorporated by reference.

### TECHNICAL FIELD

The disclosure relates to a technical field of preparation of liquid crystal synergistic high-conductivity silicone rubber composite material, in particular to a preparation method of liquid crystal synergistic high-conductivity silicone rubber composite material.

### BACKGROUND

Conductive rubber composite material is widely used in flexible sensing and electromagnetic shielding material because of their soft quality, low cost, flexibility and easy processing. Silicone rubber has well high and low temperature resistance, excellent processability, mechanical properties and unique chemical stability, and is usually used in harsh environments. However, an electrical conductivity of ordinary silicone rubber is poor, and the electrical conductivity may be significantly improved by adding conductive fillers. Commonly used conductive fillers are divided into two types: metallic conductive fillers (such as silver powder and copper powder) and carbon conductive fillers (such as conductive carbon black, graphene and carbon nanotubes).

At present, most of conductive silicone rubber sold in a market is made of acetylene black, but a preparation process is complicated, and a resistivity is still at a relatively high level, so it is not suitable for developing efficient flexible electromagnetic shielding and temperature sensor devices.

Therefore, the present disclosure provides a preparation method of liquid crystal synergistic high-conductivity silicone rubber composite material to solve the above-mentioned problems.

### SUMMARY

### Technical Problems Solved

Aiming at shortcomings of a prior art, the disclosure provides a preparation method of a liquid crystal synergistic high-conductivity silicone rubber composite material, which may improve a dispersion of conductive carbon black in a rubber matrix based on a modification of biphenyl liquid crystal unit structure material, and meanwhile, a conjugated structure of the liquid crystal unit may improve a transition ability of electrons under temperature stimulation, and has obvious synergistic effect, etc., thus solving a problem that the resistivity of conductive rubber is still at a relatively high level and is not suitable for developing efficient flexible electromagnetic shielding and temperature sensor devices.

### Technical Scheme

In order to improve the dispersion of conductive carbon black in rubber matrix, and at the same time, the conjugated structure of liquid crystal unit may improve the transition ability of electrons under temperature stimulation, and play a significant synergistic effect, the disclosure provides a following technical scheme: a preparation method of liquid crystal synergistic high-conductivity silicone rubber composite material includes the following steps:
Step 1:
first, synthesizing an intermediate 4, 4′-bis (β-hydroxyhexyloxy) biphenyl (BP6): dissolving 0.33 grams (g) dihydroxybiphenyl and 6-chloro-1-hexanol in 50 milliliter (ml) ethanol according to a molar ratio of 1:2, dispersing by ultrasound for 1 minute (min), transferring to a three-necked flask, adding sodium hydroxide solution dropwise while stirring, filtering and washing with deionized water twice after finishing, and drying to obtain the intermediate BP6.
Step 2:
synthesizing a flexible liquid crystal polyurethane (FLCPU) based on the step 1:
recrystallizing BP6: dissolving BP6 in a mixed solvent, heating and boiling for 1 min-2 min, cooling to room temperature to complete a primary recrystallization, removing supernatant, continuing to add the mixed solvent, heating and boiling for 1 min-2 min, cooling to room temperature to complete a secondary crystallization, and drying to obtain a secondary recrystallized BP6 intermediate.

Dissolving toluene diisocyanate (TDI) and BP6 in a proper amount of N, N-dimethylformamide (DMF) according to a ratio of (1.01-1.05):1, ultrasonically dispersing for 5-10 min, transferring into a three-necked flask, stirring and dropwise adding 1-4 percent (%) dibutyltin dilaurate, and reacting at 90-100 degrees Celsius (°C.) for 20-28 hours (h); cooling, filtering to obtain a sample, rinsing the sample with DMF for 2-4 times, washing with deionized water for 1-2 times, and drying to obtain a FLCPU sample.
Step 3:
mixing methyl vinyl silicone (VMQ) and the FLCPU by mechanical blending, then adding conductive carbon black and 2,5-Dimethyl-2,5-bis(hexyl) vulcanizing agent in sequence, obtaining a FLCPU modified VMQ/CCB (conductive carbon black) rubber compound after 20-25 min; hot pressing the rubber compound on a flat vulcanizer to obtain a finished product.
Step 4: testing the finished product in the step 3 before and after modification, and extracting data.

Optionally, in the step 1, 40 ml of the sodium hydroxide solution are added dropwise with stirring, then the temperature is kept at 90-100° C., and a reaction is continued with stirring for 8-10 h. The rigid structural unit in the intermediate BP6 for the step 1 is one or more of benzene ring, alicyclic ring or heterocyclic ring, and the intermediate composed of different rigid cores may also achieve an expected effect of this experiment.

Optionally, a specification of the sodium hydroxide solution is 2-2.5 mole per liter (mol/L).

Optionally, when recrystallizing the BP6 in the step 2, the mixed solvent is made by mixing 90 ml of ethanol and 30 ml of DMF; before obtaining a target sample, the synthetic FLCPU needs to be treated with a small amount of deionized water for 2-3 h.

Optionally, diisocyanate in the step 2 is any one of TDI and hexamethylene diisocyanate (HDI).

Optionally, working conditions of hot pressing of the flat vulcanizer in the step 3 are 170-175° C. for 5-10 min, and the pressure is 13-15 Megapascal (MPa).

Optionally, the mechanical blending method in the step 3 includes any one or more than one of open milling, internal milling and extrusion, and the modified carbon black may not be added into the rubber matrix when it had been decorated before by the synthesized FLCPU under the liquid phase way in the previous stage.

A dosage of modifier FLCPU in silicone rubber/CCB system is controlled at 3-5%; a feeding sequence in the step 3 must be that blending VMQ and FLCPU first, and then adding other additives such as CCB in order to ensure a modification effect.

Optionally, detection types in the step 4 include Differential Scanning calorimetry (DSC) detection, mechanical detection, scanning electron microscope analysis and volume resistivity detection.

### Beneficial Effects

Compared with the prior art, the disclosure provides a method for preparing the liquid crystal synergistic high-conductivity silicone rubber composite material, which has the following beneficial effects.

The preparation method of the liquid crystal synergistic high-conductivity silicone rubber composite material may improve the dispersion of CCB in the rubber matrix based on the modification of biphenyl liquid crystal unit structure material. The intermediate BP6 may be replaced by biphenyl or polycyclic aromatic hydrocarbons, which may also achieve the expected effect of this experiment. This increases the choice of raw materials and production efficiency for the modified product; determining the dosage of modifier in silicone rubber CCB system, and determining the FLCPU used for modification must be introduced into the rubber matrix in a form of mechanical opening, internal mixing, extrusion, etc., and the modified carbon black may not be added to the rubber after using the synthesized FLCPU to modify carbon black by liquid phase method in the previous stage, which highlights a rigorous and accurate preparation method.

According to the preparation method of the liquid crystal synergistic high-conductivity silicone rubber composite material, through the conjugated structure of the liquid crystal unit, the transition ability of electrons under temperature stimulation may be improved, and a remarkable synergistic effect may be achieved.

### BRIEF DESCRIPTION OF THE DRAWINGS

FIG. 1 is a schematic synthesis diagram of the BP6 with the present disclosure.

FIG. 2 is a synthetic schematic diagram of the FLCPU with the present disclosure.

FIG. 3 is a schematic diagram of DSC curves of the BP6 and the FLCPU synthesized by the present disclosure.

FIG. 4 is a schematic diagram of mechanical stress-strain curves of VMQ/CCB vulcanizates modified by the FLCPU with the present disclosure.

FIG. 5 is a cross-sectional scanning electron microscope (SEM) morphology diagram of VMQ/CCB composites before and after modification by the FLCPU with the present disclosure.

FIG. 6 shows the dependence of volume resistivity on the temperature for the VMQ/CCB composites before and after modification by the FLCPU.

### DETAILED DESCRIPTION OF THE EMBODIMENTS

In the following, the technical scheme of the present disclosure will be clearly and completely described through the exhibition of embodiments. Obviously, the described embodiments are only a part of the embodiments from the present disclosure, not the total embodiments. Based on the embodiments in the present disclosure, all the other embodiments in this field that obtained without creative labor by ordinary technicians all belong to the protective range of the present disclosure.

### Embodiment 1

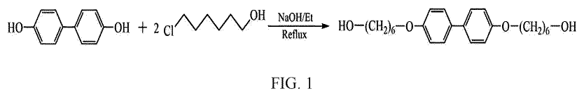

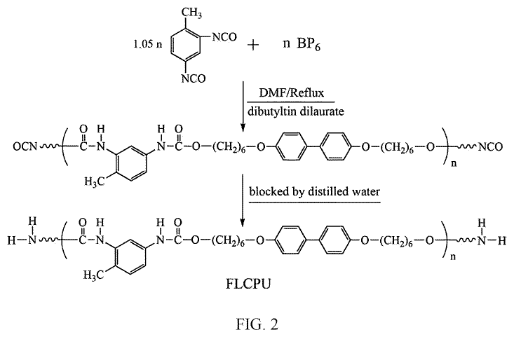

A preparation method of liquid crystal synergistic high-conductivity silicone rubber composite material, including following steps:
Step 1:
first, synthesizing an intermediate BP6: dissolving 0.33 grams (g) dihydroxybiphenyl and 6-chloro-1-hexanol in 50 milliliter (ml) ethanol according to a molar ratio of 1:2, dispersed by ultrasound for 1 minute (min), then transferring the mixture to a three-necked flask, adding sodium hydroxide solution dropwise while stirring, filtering and washing with deionized water twice after the reaction is finished, and drying to obtain the intermediate BP6. The reaction mechanism is viewed in FIG. 1. In the process, the addition of 40 ml sodium hydroxide solution is done dropwise while stirring, then keeping the temperature at 100 degrees Celsius (°C.) for 10 hours (h) with stirring to continue the reaction. The specification of sodium hydroxide solution is 2.5 mole per liter (mol/L). The rigid structural unit of intermediate BP6 in the step 1 is heterocyclic, and the intermediate composed of different rigid cores may also achieve the expected effect of this experiment.
Step 2:
synthesizing the FLCPU based on the Step 1:
recrystallizing the BP6: dissolving the BP6 in a mixed solvent, heating and boiling for 2 min, cooling to room temperature to complete a primary recrystallization, removing supernatant, repeating the above operation steps to complete a secondary crystallization, then drying the sample to obtain a secondary recrystallized BP6 intermediate; when recrystallizing the BP6, the mixed solvent is made of 90 ml ethanol and 30 ml DMF;
dissolving TDI and the BP6 in a proper amount of DMF according to a ratio of 1.05:1, ultrasonically dispersing for 10 min, transferring the mixture into a three-necked flask, followed by stirring and dropwise adding 4 percent (%) dibutyltin dilaurate, then reacting at 100° C. for 28 h; cooling, filtering to obtain a sample, rinsing the sample with DMF for 4 times, washing with deionized water twice, and drying to obtain a FLCPU sample; before obtaining the sample, the synthetic FLCPU needs to be treated for 3 h in a small amount of deionized water for sealing. The reaction mechanism of FLCPU is displayed in FIG. 2.
Step 3:
mixing VMQ and the FLCPU by mechanical blending, then adding conductive carbon black and 2,5-Dimethyl-2,5-bis(hexyl) vulcanizing agent in sequence, obtaining a VMQ/CCB rubber compound modified by FLCPU after 25 min; and hot pressing the rubber compound on a flat vulcanizer to obtain a finished product; the working conditions of the hot pressing forming with the flat vulcanizer are 175° C. for 10 min, the pressure is 15 Megapascal (MPa), the mechanical blending mode is open milling, and the dosage of modifier FLCPU in silicone rubber/CCB system is controlled at 5%.

The feeding sequence in the step 3 must be that blending the VMQ and the FLCPU first, and then adding other additives such as conductive carbon black in order to ensure the modification effect.
Step 4: testing the finished products before and after modification in the Step 3, and extracting data.

The detection types include DSC detection, mechanical detection, scanning electron microscope analysis and volume resistivity detection.

### Embodiment 2

A preparation method of liquid crystal synergistic high-conductivity silicone rubber composite material, including following steps.
Step 1:
first, synthesizing an intermediate BP6: dissolving 0.33 g dihydroxybiphenyl and 6-chloro-1-hexanol in 50 ml ethanol according to a molar ratio of 1:2, dispersed by ultrasound for 1 min, then transferring the mixture to a three-necked flask, adding sodium hydroxide solution dropwise while stirring, filtering and washing the finished sample with deionized water twice, and drying the outcome to obtain the intermediate BP6. In the process, the addition of 40 ml sodium hydroxide solution is done dropwise while stirring, then keeping the temperature at 90° C. for 8 h with stirring to continue the reaction, and the specification of sodium hydroxide solution is 2 mol/L; and the rigid structural unit in intermediate BP6 for the step 1 is heterocyclic, and the intermediate composed of different rigid cores may also achieve the expected effect of this experiment.
Step 2:
synthesizing the FLCPU based on the Step 1:
recrystallizing the BP6: dissolving the BP6 in a mixed solvent, heating and boiling for 1 min, cooling to room temperature to complete a primary recrystallization, removing supernatant, repeating the above operation to complete a secondary crystallization, then drying the sample to obtain a secondary recrystallized BP6 intermediate; when recrystallizing the BP6, the mixed solvent is made of 90 ml ethanol and 30 ml DMF;
dissolving HDI and the BP6 in a proper amount of DMF according to a ratio of 1.01:1, ultrasonically dispersing for 5 min, transferring the mixture into a three-necked flask, followed by stirring and dropwise adding 1% dibutyltin dilaurate, then reacting at 90° C. for 20 h; cooling, filtering to obtain a sample, rinsing the sample with DMF twice, washing with deionized water once, and drying the outcome to obtain a FLCPU sample; before obtaining the sample, the synthetic FLCPU needs to be treated for 2 h with a small amount of deionized water for sealing.
Step 3:
mixing VMQ and the FLCPU by mechanical blending, then adding conductive carbon black and 2,5-Dimethyl-2,5-bis(hexyl) vulcanizing agent in sequence, obtaining a VMQ/CCB rubber compound modified by FLCPU after 20 min; and hot pressing the rubber compound on a flat vulcanizer to obtain a finished product; the working conditions of hot pressing forming with the flat vulcanizer are 175° C. for 5 min, the pressure is 13 MPa, the mechanical blending mode is open milling, and the dosage of modifier FLCPU in silicone rubber CCB system is controlled at 3%.

The feeding sequence in the step 3 must be that blending VMQ and FLCPU first, and then adding other additives such as conductive carbon black in order to ensure the modification effect.
Step 4: testing the finished product before and after modification in the Step 3, and extracting data.

The detection types include DSC detection, mechanical detection, scanning electron microscope analysis and volume resistivity detection.

### Embodiment 3

A preparation method of liquid crystal synergistic high-conductivity silicone rubber composite material, including following steps.
Step 1:
first, synthesizing an intermediate BP6: dissolving 0.33 g dihydroxybiphenyl and 6-chloro-1-hexanol in 50 ml ethanol according to a molar ratio of 1:2, dispersed by ultrasound for 1 min, then transferring the mixture to a three-necked flask, adding sodium hydroxide solution dropwise while stirring, filtering and washing the finished sample with deionized water twice, and drying the outcome to obtain the intermediate BP6. In the process, the addition of 40 ml sodium hydroxide solution is done dropwise while stirring, then keeping the temperature at 95° C. for 9 h with stirring to continuing the reaction, and the specification of sodium hydroxide solution is 2 mol/L; and the rigid structural unit in the intermediate BP6 for the step 1 is heterocyclic, and the intermediate composed of different rigid cores may also achieve the expected effect of this experiment.
Step 2:
synthesizing the FLCPU based on the Step 1:
recrystallizing the BP6: dissolving the BP6 in a mixed solvent, heating and boiling for 1 min, cooling to room temperature to complete a primary recrystallization, then removing supernatant, continuing to add the mixed solvent, heating and boiling for 2 min, cooling to room temperature to complete a secondary crystallization, and drying the sample to obtain a secondary recrystallized BP6 intermediate; when recrystallizing the BP6, the mixed solvent is made of 90 ml ethanol and 30 ml DMF;
dissolving TDI and the BP6 according to a ratio of 1.01:1 in a proper amount of DMF, ultrasonically dispersing for 8 min, transferring the mixture into a three-necked flask, followed by stirring and dropwise adding 3% dibutyltin dilaurate, then reacting at 90° C. for 24 h; cooling, filtering to obtain a sample, rinsing the sample with DMF for 3 times, washing with deionized water once, and drying the outcome to obtain a FLCPU sample; before obtaining the sample, the synthetic FLCPU needs to be treated for 2 h in a small amount of deionized water for sealing.
Step 3:
mixing the VMQ and the FLCPU by mechanical blending, then adding conductive carbon black and 2,5-Dimethyl-2,5-bis(hexyl) vulcanizing agent in sequence, obtaining a VMQ/CCB rubber compound modified by FLCPU after 24 min; and hot pressing the rubber compound on a flat vulcanizer to obtain a finished product; the working conditions of hot pressing forming with the flat vulcanizer are 173° C. for 7 min, the pressure is 14 MPa, the mechanical blending mode is open milling, and the dosage of modifier FLCPU in silicone rubber/CCB system is controlled at 4%.

The feeding sequence in the step 3 must be that blending VMQ and FLCPU first, and then adding other additives such as conductive carbon black in order to ensure the modification effect.
Step 4: testing the finished product before and after modification in the Step 3, and extracting data.

The detection types include DSC detection, mechanical detection, scanning electron microscope analysis and volume resistivity detection.

### Test results

### DSC Curve of the FLCPU

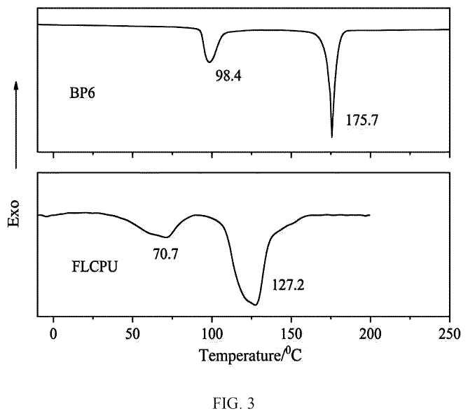

FIG. 3 displays the DSC curves of synthesized BP6 and FLCPU. In FIG. 3, 98.4° C. and 175.7° C. respectively represent a melting point Tₘ and isotropic transition point of the crystalline structure in BP6 (namely a clear point Tᵢ of a liquid crystal structure). Similarly, 70.7° C. and 127.2° C. respectively represent the melting point of crystal structure and the clearing point of liquid crystal phase transition in FLCPU based on the BP6 as structural unit, indicating the synthesized flexible polyurethane (PU) has typical liquid crystal structure characteristics, and a liquid crystal temperature range is 70-130° C.

### Mechanical Properties of Material Before and After FLCPU Modification

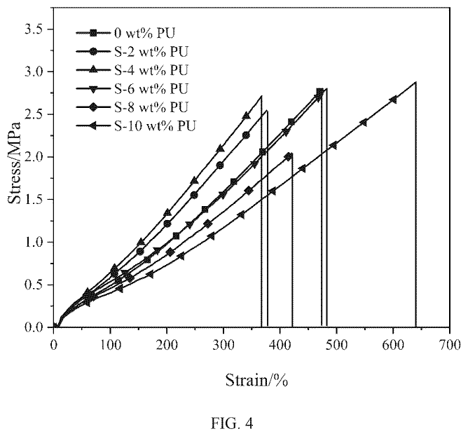

FIG. 4 demonstrates the mechanical stress-strain curves of the VMQ/CCB composites modified by FLCPU. As may be seen from the FIG. 4, with an increased content of the FLCPU in the system, the stress at definite elongation of composite first increases and then decreases, and the elongation at break shows the opposite characteristic of change. When adding 4% FLCPU, the stress at definite elongation of the composite is significantly increased, a tensile strength is effectively maintained, and comprehensive mechanical properties are significantly improved.

### Scanning Electron Microscope Analysis of Composite Before and After Modification by FLCPU

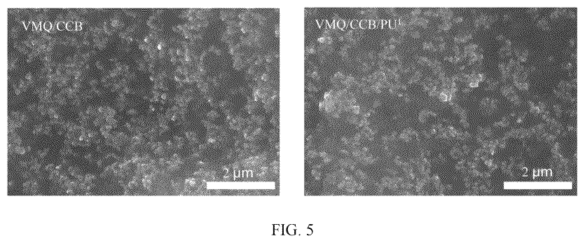

FIG. 5 shows a dispersed morphology of carbon black in silicone rubber matrix before and after modification by FLCPU. As may be seen from FIG. 5, the size of carbon black aggregate decreases after involving PU, and the dispersion of carbon black in rubber matrix is significantly improved, which is beneficial to improve mechanical and electrical properties of composite material.

### Volume Resistivity Changes of Composite Before and After Modification by FLCPU

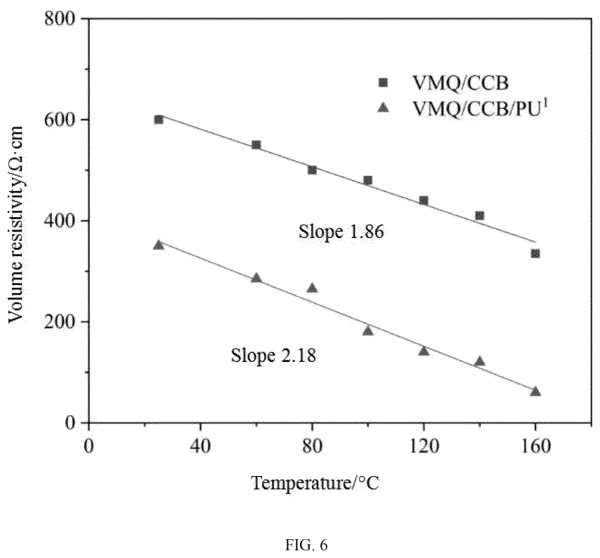

FIG. 6 shows the change of volume resistivity of VMQ/CCB composites before and after modification by FLCPU via changing temperature, and the corresponding values are shown in Table 1. As seen in FIG. 6, the resistivity of the modified material is significantly reduced at the same temperature, showing good conductive synergistic characteristics, indicating an improvement of carbon black dispersion after PU modification is helpful to reduce an overall resistivity of the material. Meanwhile, with a continuous increase of temperature, the composite material shows obvious negative temperature coefficient effect, the reason is that heating improves the transition ability of electrons in the system and improves the conductivity of the material. In addition, a decrease rate of volume resistivity for the modified material with the increase of temperature is obviously stronger than the decrease rate of an unmodified system, showing a higher linear fitting slope value, which shows the conjugated structure of liquid crystal is helpful to a migration of free electrons on the surface of carbon black in the system and improves the conductivity of the material. Further observation form the Table 1 presents that when the temperature exceeds 80° C., compared with the unmodified system, the decrease in volume resistivity of the composite suddenly increases from more than 40% at the low temperature region to more than 60%, the high temperature region is in the phase transition region of liquid crystal, which fully shows the role of the liquid crystal in improving the conductivity of the whole material, and proves a remarkable effect of the conjugated structure of liquid crystal unit in guiding or assisting a free electron migration of carbon black.

### Volume Resistivity of VMQ/CCB Composite Material Before and After FLCPU Modification at Different Temperatures

TABLE 1
The disclosure has the beneficial effects that: the preparation method of the liquid

| | | Temperature/° C. | | | | | | |
|---|---|---|---|---|---|---|---|---|
| Project name | | 25 | 60 | 80 | 100 | 120 | 140 | 160 |
| VMQ/CCB | Volume | 600 | 550 | 500 | 480 | 440 | 410 | 335 |
| | resistivity/Ohm | | | | | | | |
| | centimeter(Ω · cm) | | | | | | | |
| VMQ/CCB/PU¹ | Volume | 350 | 285 | 265 | 180 | 140 | 120 | 60 |
| | resistivity/Ω · cm | | | | | | | |
| | Decline/% | 41.7 | 48.2 | 47.0 | 62.5 | 68.2 | 70.7 | 82.1 |

crystal synergistic high-conductivity silicone rubber composite may improve the dispersion of CCB in the rubber matrix based on the modification of biphenyl liquid crystal unit structure, the intermediate BP6 may be replaced by the biphenyl or polycyclic aromatic hydrocarbons, which may also achieve the expected effect of this experiment. This increases the selectivity of raw material for the product and improves the production efficiency of the product; determining the dosage of modifier in silicone rubber CCB system, and determining the FLCPU used for modification must be introduced into the rubber composite in a form of mechanical open milling, internal mixing, extrusion, etc., and the carbon black modified by the synthesized FLCPU under liquid phase way in the previous stage before using may not be added into the rubber matrix, which highlights the rigor and accuracy of the disclosed preparation method test. At the same time, the conjugated structure of liquid crystal unit may improve the transition ability of electrons under temperature stimulation and play a significant synergistic effect.

Although embodiments of the present disclosure have been shown and described, it will be understood by the normal technicists in the field that various changes, modifications, substitutions and variations may be made to these embodiments without departing from the principles and spirit of the present disclosure, the scope of which is defined by the appended claims and their equivalents.

What is claimed is:

1. A preparation method of liquid crystal synergistic high-conductivity silicone rubber composite, comprising following steps:
step 1:
first, synthesizing an intermediate 4, 4′-bis (β-hydroxyhexyloxy) biphenyl (BP6): dissolving 0.33 g dihydroxybiphenyl and 6-chloro-1-hexanol in 50 ml ethanol according to a molar ratio of 1:2, dispersing by ultrasound for 1 min, transferring a mixture to a three-necked flask, adding sodium hydroxide solution dropwise while stirring, filtering and washing with deionized water twice after finishing, and drying to obtain the intermediate BP6;
step 2:
synthesizing a flexible liquid crystal polyurethane (FLCPU) based on the step 1:
recrystallizing the BP6: dissolving the BP6 in a mixed solvent, heating and boiling for 1 min-2 min, cooling to room temperature to complete a primary recrystallization, removing supernatant, repeating above operation steps to complete a secondary crystallization, and drying to obtain a secondary recrystallized BP6 intermediate; and
dissolving toluene diisocyanate (TDI) and the BP6 in a proper amount of N, N-dimethylformamide (DMF) according to a ratio of (1.01-1.05):1, ultrasonically dispersing for 5-10 min, transferring a mixture into the three-necked flask, then stirring and dropwise adding 1-4% dibutyltin dilaurate, and reacting at 90-100° C. for 20-28 h; and cooling, filtering to obtain a sample, rinsing the sample with the DMF for 2-4 times, washing with the deionized water for 1-2 times, and drying an outcome to obtain a FLCPU sample;
step 3:
mixing methyl vinyl silicone (VMQ) and the FLCPU by a mechanical blending mode, then adding conductive carbon black (CCB) and 2,5-Dimethyl-2,5-bis(hexyl) vulcanizing agent in sequence, obtaining a VMQ/CCB rubber compound modified by the FLCPU after 20-25 min; and hot pressing the VMQ/CCB rubber compound on a flat vulcanizer to obtain a finished product; and
step 4: testing the finished product before and after modification in the step 3, and extracting data.

2. The preparation method of the liquid crystal synergistic high-conductivity silicone rubber composite according to claim 1, wherein in the step 1, 40 ml of the sodium hydroxide solution is added dropwise while stirring, then temperature is kept at 90-100° C. and a reaction is continuously stirred for 8-10 h.

3. The preparation method of the liquid crystal synergistic high-conductivity silicone rubber composite according to claim 2, wherein a specification of the sodium hydroxide solution is 2-2.5 mole per liter (mol/L).

4. The preparation method of the liquid crystal synergistic high-conductivity silicone rubber composite according to claim 1, wherein when recrystallizing the BP6 in the step 2, the mixed solvent is prepared by mixing 90 ml of the ethanol and 30 ml of the DMF; and before obtaining a final FLCPU, end-capping treatment is required using 0.3 wt %-0.6 wt % of the deionized water of FLCPU for 2-3 h.

5. The preparation method of the liquid crystal synergistic high-conductivity silicone rubber composite according to claim 1, wherein in the step 3, working conditions of the hot pressing on the flat vulcanizer are 170-175° C. for 5-10 min and a pressure of 13-15 MPa.

6. The preparation method of the liquid crystal synergistic high-conductivity silicone rubber composite according to claim 1, wherein the mechanical blending mode in the step 3 comprises any one or more of open milling and internal milling, and a dosage of the FLCPU in a high-conductivity silicone rubber composite material is controlled at 3-5%; and a feeding sequence in the step 3 must be blending the VMQ and the FLCPU first, and then adding other additives in sequence to ensure a modification effect is achieved.

7. The preparation method of the liquid crystal synergistic high-conductivity silicone rubber composite according to claim 1, wherein detection types in the step 4 comprise differential scanning calorimetry (DSC) detection, mechanical detection, scanning electron microscope analysis and volume resistivity detection.
